(19) United States
(12) Patent Application Publication
(10) Pub. No.: US 2009/0321101 A1
(43) Pub. Date: Dec. 31, 2009

(54) Power tool

(75) Inventors: Masanori Furusawa, Anjo-shi (JP); Yoshihiro Kasuya, Anjo-shi (JP)

Correspondence Address: OLIFF & BERRIDGE, PLC, P.O. BOX 320850, ALEXANDRIA, VA, 22320-4850, US

(73) Assignee: MAKITA CORPORATION, Anjo-shi (JP)

(21) Appl. No.: 12/457,777

(22) Filed: Jun. 22, 2009

(30) Foreign Application Priority Data
Jun. 26, 2008 (JP) 2008-167791
Jun. 26, 2008 (JP) 2008-167792
Jun. 27, 2008 (JP) 2008-168770

(51) Int. Cl. B25D 17/04; B25D 17/24

(52) U.S. Cl. 173/162.2

(57) ABSTRACT

It is an object of the invention to provide a technique which contributes to reduced size of a vibration-proof handle for a hand-held power tool. A representative hand-held power tool includes a power tool body 103 having a tip end region to which a tool bit 119 can be coupled, and a handle 109 arranged on the rear of the power tool body 103 on the side opposite to the tool bit 119 and designed to be held by a user. The handle 109 is connected to the power tool body 103 via elastic elements 181, 183 and can slide with respect to the power tool body 103 in an axial direction of the tool bit 119. The power tool body 103 has an extending region 105b that extends to a lower region of the handle 109 and receives the sliding movement of the handle 109.

### BACKGROUND OF THE INVENTION

1. Field of the Invention

The present invention relates to a vibration-proof handle of a hand-held power tool such as a hammer and a hammer drill.

2. Description of the Related Art

A hand-held electric hammer having a vibration-proof handle is disclosed, for example, in Japanese non-examined laid-open Patent Publication No. 2005-219195. In this electric hammer, the vibration-proof handle to be held by a user during hammering operation is mounted to a hammer body via an elastic element for vibration absorption. More specifically, in the vibration-proof handle, one (lower) end of a grip part in its longitudinal direction is mounted to the rear of the hammer body such that it can rotate with respect to the hammer body on a pivot in the axial direction of the tool bit, and the other (upper) end is connected to the rear of the hammer body via the elastic element.

In the above-described rotary vibration-proofhandle which is supported via the pivot for relative rotation, the elastic element deforms into an arcuate shape around the pivot. Therefore, if an attempt is made to obtain a desired vibration proofing effect by causing the direction of deformation of the elastic element to be closer to the axial direction of the hammer bit, the distance between the pivot and the elastic element is widened, which results in size increase of the handgrip in the vertical direction. Therefore, such a rotary vibration-proof handle is not suitable for application to a relatively small power tools. In this point, further improvement is required.

### SUMMARY OF THE INVENTION

Accordingly, it is an object of the present invention to provide a technique which contributes to reduced size of a vibration-proof handle in a hand-held power tool.

In order to solve the above-described problem, in a preferred embodiment according to the present invention, a hand-held power tool which linearly drives a tool bit so as to cause the tool bit to perform a predetermined operation on a workpiece includes a power tool body having a tip end region to which the tool bit can be coupled, and a handle arranged on the rear of the power tool body on the side opposite to the tool bit and designed to be held by a user. The “hand-held power tool” may typically represent a hammer which performs a hammering operation on a workpiece by striking movement of a tool bit in its axial direction. Further, it may also include a hammer drill and a cutting power tool such as a reciprocating saw and a jig saw.

According to the preferred embodiment of the hand-held power tool in this invention, the handle is connected to the power tool body via an elastic element and can slide with respect to the power tool body in an axial direction of the tool bit. Further, the power tool body has an extending region that extends to a lower region of the handle and receives the sliding movement of the handle. The “elastic element” in this invention typically represents a spring or a rubber. The structure in which the extending region receives the sliding movement of the handle suitably includes a structure in which flat surfaces slide in contact with respect to each other, a sliding structure formed by a groove extending in the axial direction of the tool bit and a protrusion which is engaged with the groove, and a sliding structure formed by a slot extending in the axial direction of the tool bit and a rod-like member which is inserted in the slot.

In this invention, the handle is elastically connected to the power tool body such that it can slide with respect to the power tool body in the axial direction of the tool bit. Therefore, the elastic element can absorb vibration by linear deformation in the axial direction of the tool bit, so that the vibration absorption efficiency of the elastic element can be enhanced. Further, with the construction in which the handle linearly moves with respect to the power tool body, unlike the known rotary handle, the vertical length of the handle is not restricted, so that the size of the handle can be reduced. Further, in this invention, with the construction in which the power tool body has an extending region that extends to a lower region of the handle and receives the sliding movement of the handle, the handle can be supported with stability.

According to a further embodiment of the hand-held power tool in this invention, the handle includes a grip part that extends in a vertical direction transverse to the axial direction of the tool bit, upper and lower arms that extend from extending ends of the grip part in the axial direction of the tool bit, and a transverse part that connects extending ends of the upper and lower arms, so that the handle is configured as a closed-loop frame structure. According to this invention, by provision of such a closed-loop frame structure, the rigidity of the handle can be increased. Therefore, this structure is effective in preventing damage to the handle in the event of drop of the power tool.

According to a further embodiment of the hand-held power tool in this invention, a side surface region of the handle which is parallel to the axial direction of the tool bit has a sliding surface that can slide with respect to the power tool body. The “side surface region of the handle” in this invention represents side surface regions of the arms and the transverse part. According to this invention, by provision for the side surface region of the handle to have the sliding surface that can slide with respect to the power tool body, rattling can be reduced in a lateral direction transverse to the sliding surface. As a result, relative movement of the handle with respect to the power tool body can be stabilized. Further, even if the spring constant of the elastic element is reduced, a sufficient vibration proofing effect can be obtained.

According to a further embodiment of the hand-held power tool in this invention, the sliding surface includes a first sliding region extending in the axial direction of the tool bit, and a second sliding region extending in a vertical direction transverse to the extending direction of the first sliding region. The first sliding region is provided on the side surfaces of the arms and the second sliding region is provided on the side surface of the transverse part. According to this invention, with the construction in which the handle has the first sliding region extending in the axial direction of the tool bit and the second sliding region extending in a vertical direction transverse to the axial direction of the tool bit, a relatively wide sliding surface can be formed, so that rattling of the handle with respect to the power tool body can be further reduced.

According to a further embodiment of the hand-held power tool in this invention, the hand-held power tool further includes an electric motor that drives the tool bit, and a battery pack from which the electric motor is powered. The extending region extending to the lower region of the handle forms a battery pack mounting part to which the battery pack is detachably mounted. According to this invention, in the battery-powered hand-held power tool in which the electric motor is powered from the battery pack, the extending region extending from the power tool body can be rationally used as a sliding guide region for the handle and as a mount for the battery pack.

According to a further embodiment of the hand-held power tool in this invention, the power tool body and the handle are connected to each other via a guide, and at upper and lower end portions of the handle, the guide allows the handle to slide with respect to the power tool body in the axial direction of the tool bit, while preventing the handle from moving with respect to the power tool body in any direction except the axial direction of the tool bit. According to this invention, rattling of the handle can be reduced in the vertical direction as well as in the lateral direction, so that rattling can be further reduced.

According to a further embodiment of the hand-held power tool in this invention, the guide includes a concave groove extending in the axial direction of the tool bit and a projection that is engaged with the concave groove for relative movement, and the projection comprises a metal pin. The concave groove is formed of a different material from the metal pin. Further, naturally, one of the concave groove and the projection is formed on the power tool body side and the other is formed on the handle side. Preferably, in order to achieve the weight reduction, at least the side on which the groove is formed may be made of synthetic resin or aluminum alloy. According to this invention, the protrusion and the groove which slide with respect to each other are formed of heterogeneous materials so that the sliding ability can be improved.

Other objects, features and advantages of the present invention will be readily understood after reading the following detailed description together with the accompanying drawings and the claims.

### BRIEF DESCRIPTION OF THE DRAWINGS

FIG. 1 is an external view showing an entire structure of a battery-powered hammer drill according to an embodiment of the present invention.

FIG. 2 is a side view showing an internal structure of the battery-powered hammer drill by broken line and partly in section.

FIG. 3 shows a vibration-proof structure of a handgrip in its initial state (mounted state) in which the handgrip is in the most rearward position.

FIG. 4 shows the vibration-proof structure of the handgrip in the state of maximum displacement in which the handgrip is in the most forward (housing-side) position.

FIG. 5 is a sectional view taken along line A-A in FIG. 3.

FIG. 6 is a sectional view taken along line B-B in FIG. 3.

FIG. 7 is a view showing an entire hammer drill.

FIG. 8(A) is a view illustrating an output shaft region, FIG. 8(B) is a view from a direction shown by the arrow A, and FIG. 8(C) is a view from a direction shown by the arrow B.

FIG. 9 is an enlarged view of the output shaft region.

FIG. 10 is a view illustrating the state in which a front housing is removed.

FIG. 11 is a view illustrating the state in which a right housing is removed.

FIG. 12(A) is a sectional view taken along line C-C in FIG. 11, FIG. 12(B) is a sectional view taken along line D-D in FIG. 11.

FIG. 13 is a cross-sectional view showing a rear end part of the inner housing.

### DETAILED DESCRIPTION OF THE INVENTION

Each of the additional features and method steps disclosed above and below may be utilized separately or in conjunction with other features and method steps to provide and manufacture improved power tools and method for using such power tools and devices utilized therein. Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

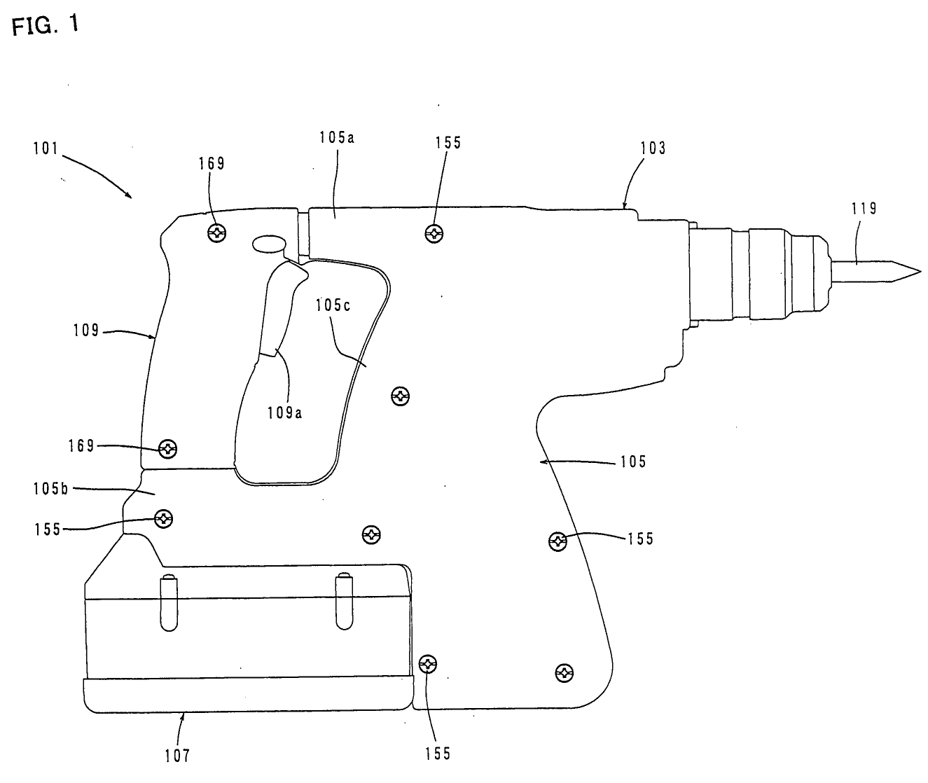

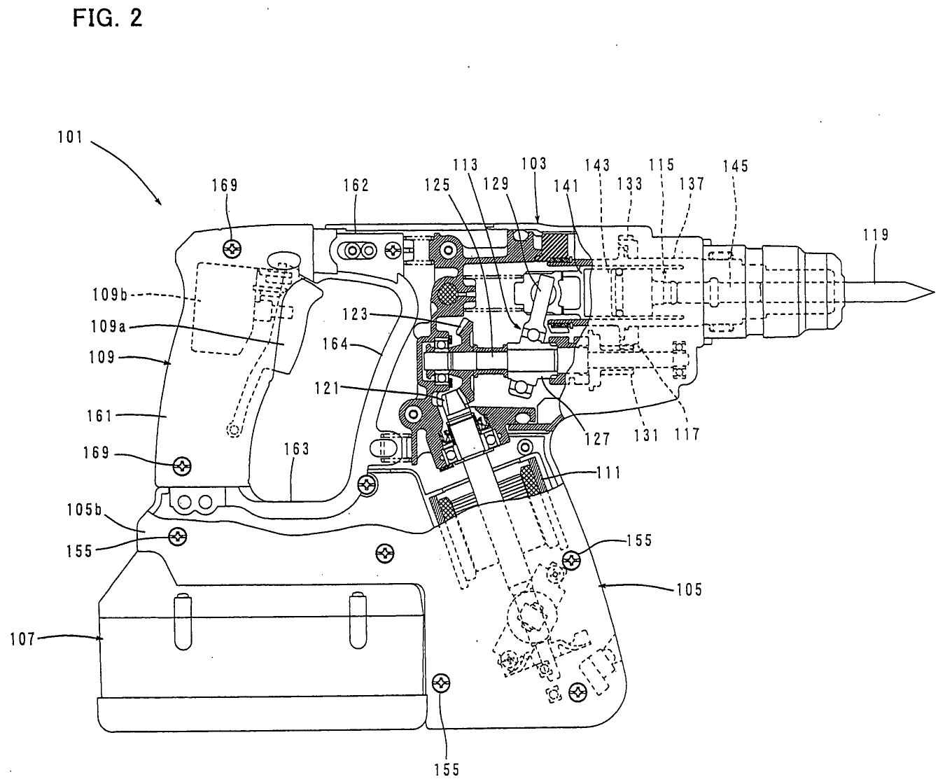

A representative embodiment of the present invention is now described with reference to FIGS. 1 to 6. In this embodiment, a battery-powered hammer drill is explained as a representative example of a hand-held power tool according to the present invention. FIG. 1 shows an entire structure of the hammer drill 101 according to this embodiment, and FIG. 2 is a side view showing an internal structure of the hammer drill 101 by broken line and partly in section. As shown in FIG. 1, the hammer drill 101 mainly includes a body 103 that forms an outer shell of the hammer drill 101, a hammer bit 119 detachably coupled to the tip end region of the body 103 via a tool holder 137, a handgrip 109 connected to the body 103 on the side opposite to the hammer bit 119 and designed to be held by a user, and a battery pack 107 attached to the underside of the body 103. The body 103, the hammer bit 119 and the handgrip 109 are features that correspond to the “power tool body”, the “tool bit” and the “handle”, respectively, according to the present invention. The hammer bit 119 is held by the tool holder 137 such that it is allowed to reciprocate with respect to the tool holder in its axial direction and prevented from rotating with respect to the tool holder in its circumferential direction. In the present embodiment, for the sake of convenience of explanation, the side of the hammer bit 119 is taken as the front side and the side of the handgrip 109 as the rear side.

As shown in FIG. 2, the body 103 mainly includes a housing 105 that houses an electric motor 111, a motion converting mechanism 113, a striking mechanism 115 and a power transmitting mechanism 117. The rotating output of the electric motor 111 is appropriately converted into linear motion via the motion converting mechanism 113 and transmitted to the striking mechanism 115. Then, an impact force is generated in the axial direction of the hammer bit 119 via the striking mechanism 115. Further, the power transmitting mechanism 117 appropriately reduces the speed of the rotating output of the electric motor 111 and then transmits the rotating output to the hammer bit 119. As a result, the hammer bit 119 is caused to rotate in the circumferential direction. The electric motor 111 is driven when an electric switch 109b is turned on by depressing a trigger 109a on the handgrip 109.

The electric motor 111 is disposed in a lower region within the housing 105 and arranged such that its axis of rotation extends obliquely with respect to the vertical direction and transversely to the axial direction of the hammer bit 119. The motion converting mechanism 113 mainly includes a driving gear 121 that is rotated by the electric motor 111, a driven gear 123 that engages with the driving gear 121 and is rotated in a vertical plane, a rotating element 127 that rotates together with the driven gear 123 via an intermediate shaft 125, a swinging member in the form of a swinging ring 129 that is caused to swing in the axial direction of the hammer bit 119 by rotation of the rotating element 127, and a driving element in the form of a cylindrical piston 141 that is caused to reciprocate by swinging movement of the swinging ring 129. The swinging ring 129 is rotatably supported on the rotating element 127 via a bearing. The rotating element 127 and the swinging ring 129 form a swinging mechanism.

The cylindrical piston 141 has a closed end (closed rear end). The cylindrical piston 141 is slidably disposed within the cylindrical tool holder 137 that is disposed coaxially with the cylindrical piston 141. The cylindrical piston 141 is driven by swinging movement (by its components in the axial direction of the hammer bit 119) of the swinging ring 129, and reciprocates along the tool holder 137.

The striking element 115 mainly includes a striking element in the form of a striker 143 slidably disposed within the bore of the cylindrical piston 141, and an intermediate element in the form of an impact bolt 145 that is slidably disposed within the tool holder 137 and serves to transmit the kinetic energy of the striker 143 to the hammer bit 119. The striker 143 is then driven (linearly moved) by pressure fluctuations of air (the action of an air spring) within an air chamber of the cylindrical piston 141 as a result of the sliding movement of the piston 141. The striker 143 then collides with (strikes) the impact bolt 145 which is slidably disposed within the tool holder 137, and transmits the striking force to the hammer bit 119 via the impact bolt 145. The cylindrical piston 141, the striker 143 and the impact bolt 145 form a bit striking mechanism.

The power transmitting mechanism 117 mainly includes a first transmission gear 131 that is caused to rotate in a vertical plane by the electric motor 111 via the intermediate shaft 125, and a second transmission gear 133 that is engaged with the first transmission gear 131 and coaxially mounted on the tool holder 137. The rotational driving force of the second transmission gear 133 is transmitted to the tool holder 137 and then to the hammer bit 119 held by the tool holder 137.

In the hammer drill 101 thus constructed, when the electric motor 111 is driven, a striking force is applied to the hammer bit 119 in the axial direction from the motion converting mechanism 113 via the striking mechanism 115, and at the same time, a rotating force is also applied to the hammer bit 119 in the circumferential direction via the power transmitting mechanism 117. Thus, the hammer bit 119 performs a drilling operation on a workpiece (concrete) by a hammering movement in the axial direction and a drilling movement in the circumferential direction.

The hammer drill 101 can be appropriately switched between a hammering operation mode in which only a striking force in the axial direction is applied to the hammer bit 119, and a hammer drill operation mode in which a striking force in the axial direction and a rotating force in the circumferential direction are applied to the hammer bit 119. This construction is not directly related to this invention and therefore will not be described.

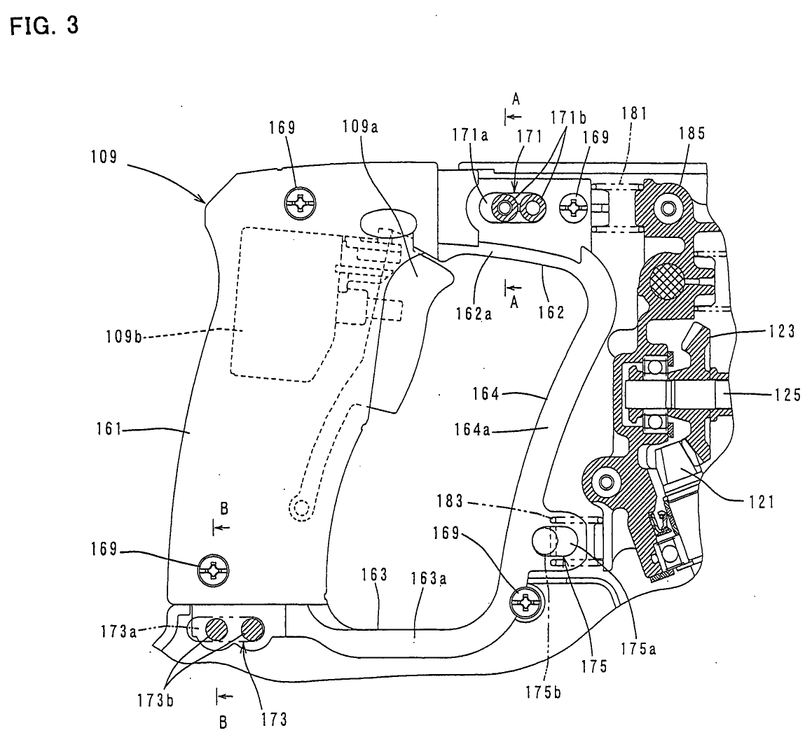

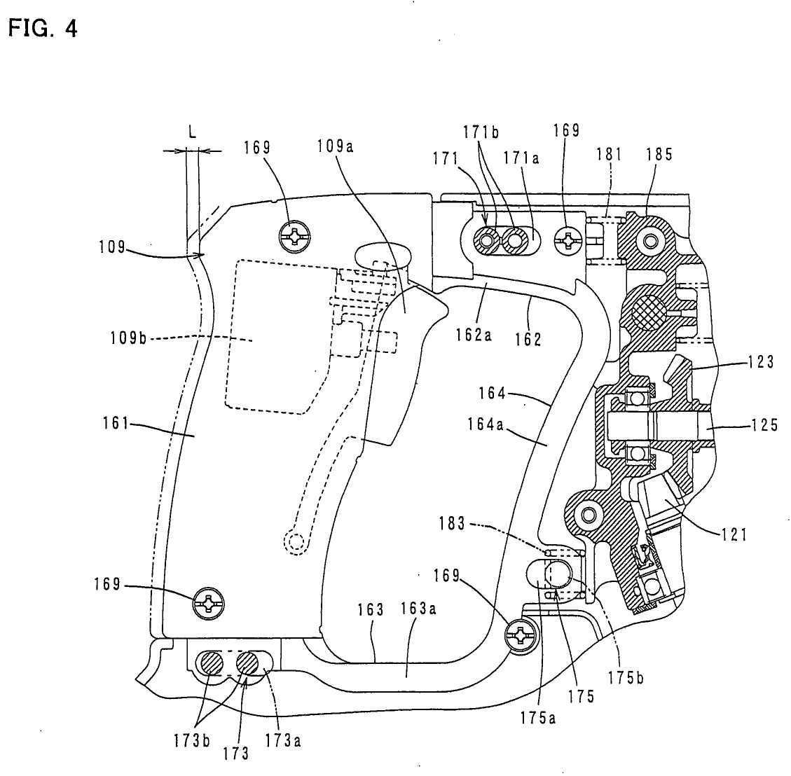

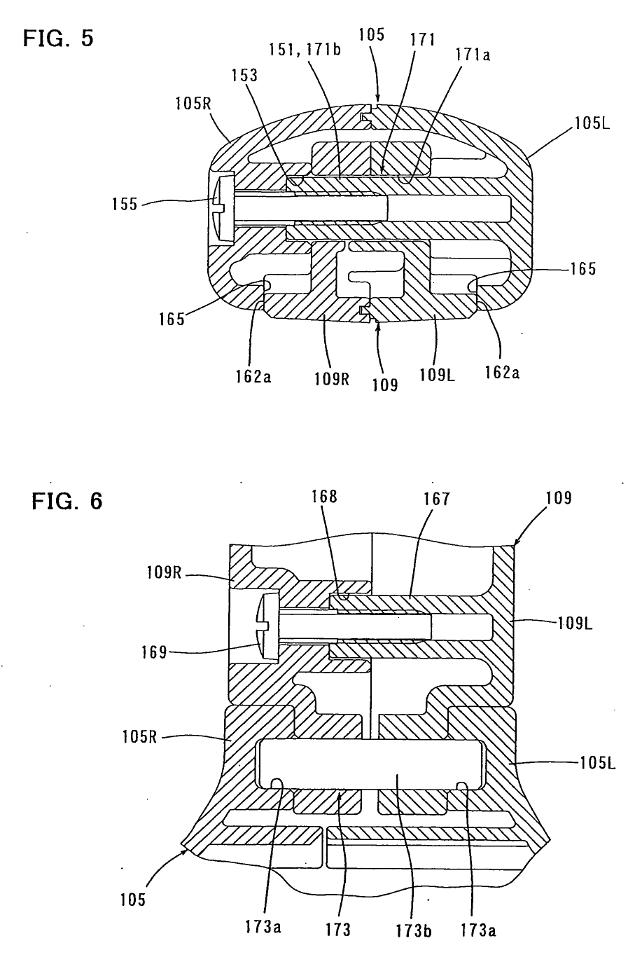

Next, a vibration-proof structure of the handgrip 109 is described with reference to FIGS. 3 to 6. FIGS. 3 and 4 show the vibration-proof structure of the handgrip 109, and FIGS. 5 and 6 are sectional views taken along line A-A and line B-B in FIG. 3, respectively. As shown in FIGS. 5 and 6, the hollow housing 105 forming the body 103 includes right and left housing halves 105L, 105R into which the housing 105 is split in the axial direction of the hammer bit 119. FIGS. 3 and 4 show the state in which the housing half 105L on the left side of the hammer drill 101 as viewed from the front is removed. On one of the right and left housing halves 105L, 105R, or, for example, the left housing half 105L, as shown in FIG. 5, a plurality of cylindrical dowels 151 are integrally formed on its edge region on the mating face side (the inner surface side) and protrude in a direction perpendicular to the mating face. In the right housing half 105R, a plurality of dowel holes 153 are formed to correspond with the dowels 151. The dowels 151 are fitted in the dowel holes 153, and in this state, the right and left housing halves 105L, 105R are joined to each other by screws 155 through the dowels.

As shown in FIGS. 3 and 4, the handgrip 109 includes a grip part 161 extending in a vertical direction transverse to the axial direction of the hammer bit 119, upper and lower arms 162, 163 extending from extending ends of the grip part in a horizontal direction transverse to the extending direction of the grip part, and a stay 164 that extends substantially parallel to the grip part 161 and connects the extending ends of the upper and lower arms 162, 163, so that the handgrip 109 is configured as a closed-loop integral frame structure. With this structure, the rigidity of the handgrip 109 can be increased. Therefore, this structure is effective in preventing damage to the handgrip 109 in the event of drop of the hammer drill 101. The stay 164 is a feature that corresponds to the “transverse part” according to this invention.

Further, as shown in FIGS. 5 and 6, like the housing 105, the handgrip 109 includes right and left handgrip halves 109L, 109R into which the handgrip 109 is split in the axial direction of the hammer bit 119. On one of the right and left handgrip halves 109L, 109R, or, for example, the left handgrip half 109L, a plurality of cylindrical dowels 167 are integrally formed on its edge region on the mating face side (the inner surface side) and protrude in a direction perpendicular to the mating face. In the right handgrip half 109R, a plurality of dowel holes 168 are formed to correspond with the dowels 167. The dowels 167 are fitted in the dowel holes 168, and in this state, the right and left handgrip halves 109L, 109R are joined to each other by screws 169 through the dowels.

As shown in FIG. 1, a rear region of the housing 105 is generally U-shaped in side view, having an upper extending portion 105a extending to the upper arm 162 of the handgrip 109, a lower extending portion 105b extending to the lower arm 163, and an intermediate portion 105c extending therebetween. Openings are formed in a lower surface and a rear end surface of the upper extending portion 105a, an upper surface of the lower extending portion 105b and a rear surface of the intermediate portion 105c. The upper and lower arms 162, 163 and the stay 164 of the handgrip 109 are inserted into the upper extending portion 105a, the lower extending portion 105b and the intermediate portion 105c, respectively, through the openings, and can move in the axial direction of the hammer bit 119. The lower extending portion 105b is a feature that corresponds to the “extending region” according to this invention. Further, the battery pack 107 is detachably mounted on the underside of the lower extending portion 105b of the housing 105. Specifically, the lower extending portion 105b also serves as a mount for the battery pack 107.

Thus, all parts of the handgrip 109 except the grip part 161 are held (enclosed) by the generally U-shaped rear region of the housing 105 from laterally outward. In this state, the handgrip 109 is supported in such a manner as to be movable with respect to the housing 105 in the axial direction of the hammer bit 119. Further, the handgrip 109 is connected at the front end to the housing 105 via upper and lower coil springs 181, 183. As shown in FIGS. 3 and 4, the upper coil spring 181 is elastically disposed between a front end surface of the upper arm 162 and a rear wall surface of an inner housing 185 disposed within the housing 105. The lower coil spring 183 is elastically disposed between a front lower portion of the stay 164 and the rear wall surface of the inner housing 185.

The right and left side surfaces of the upper and lower arms 162, 163 and the right and left side surfaces of the stay 164 in the handgrip 109 have smooth surfaces 162a, 163a, 164a parallel to the axial direction of the hammer bit 119, in part or in entirety. The smooth surfaces 162a, 163a of the upper and lower arms 162, 163 extend in the axial direction of the hammer bit 119, and the smooth surface 164a of the stay 164 extends vertically in a direction transverse to the axial direction of the hammer bit 119. The smooth surfaces 162a, 163a, 164a are slidably held in contact with opening edges (wall surfaces) 165 (see FIG. 5) of the openings of the upper extending portion 105a, the lower extending portion 105b and the intermediate portion 105c.

Specifically, the opening edges 165 form sliding guide surfaces which slide in surface contact with the smooth surfaces 162a, 163a, 164a. The structures of contact between the smooth surfaces 163a, 164a of the lower arm 163 and the stay 164 and the opening edges of the lower extending portion 105b and the intermediate portion 105c, which are not shown, are similarly configured as the structure of contact between the smooth surface 162a of the upper arm 162 and the opening edge 165 of the upper extending portion 105a, which is shown in FIG. 5. With this construction, rattling of the handgrip 109 with respect to the housing 105 can be reduced in a horizontal (lateral) direction transverse to the axial direction of the hammer bit 119, which results in stabilization of relative sliding movement of the handgrip 109 in the axial direction of the hammer bit 119. The smooth surfaces 162a, 163a, 164a are features that correspond to the “sliding surface” according to this invention. The smooth surfaces 162a, 163a of the upper extending portion 105a and the lower extending portion 105b and the smooth surface 164a of the stay 164 are features that correspond to the “first sliding region” and the “second sliding region”, respectively, according to this invention.

Slide guides 171, 173, 175 are provided between the upper arm 162 of the handgrip 109 and the upper extending portion 105a of the housing 105, between the lower arm 163 and the lower extending portion 105b and between the stay 164 and the intermediate portion 105c. The upper and lower slide guides 171, 173 are features that correspond to the “guide” according to this invention. As shown in FIGS. 3 to 5, the upper slide guide 171 includes a slot 171a that is formed generally in the middle of the upper arm 162 in its extending direction, and a protrusion 171b that is formed on the upper extending portion 105a and slidably inserted through the slot 171a. The above-described cylindrical dowel 151 formed on the left housing half 105L also serves as the protrusion 171b. In this embodiment, two dowels 151 are disposed side by side in the axial direction of the hammer bit 119 in such a manner as to serve also as protrusions 171b. The slot 171a is formed through the upper arm in the lateral direction (see FIG. 5) and has a predetermined length extending in the axial direction of the hammer bit 119 (see FIGS. 3 and 4).

As shown in FIGS. 3, 4 and 6, the lower slide guide 173 includes protrusions in the form of two metal pins 173b mounted to a rear end portion (an area of connection with the grip part 161) of the lower arm 163, and concave grooves 173a (shown by two-dot chain line in FIGS. 3 and 4) formed in the inner surface of the upper rear-end portion of the lower extending portion 105b (in the inner surfaces of the right and left housing halves 105L, 105R). The ends of each of the metal pins 173b are slidably engaged in the concave grooves 173a. The two metal pins 173b extend through the lower arm 163 in the lateral direction and are disposed side by side with a predetermined spacing therebetween in the axial direction of the hammer bit 119. The extending ends (axial ends) of the metal pins 173b are engaged in the concave grooves 173a. The concave grooves 173a have a predetermined length extending in the axial direction of the hammer bit 119. The right and left housing halves 105L, 105R having the concave grooves 173a are formed of a different material from the metal pins 173b, for example, a light material such as synthetic resin and aluminum. The sliding structure formed of heterogeneous materials can obtain higher sliding ability.

Further, as shown in FIGS. 3 and 4, the intermediate slide guide 175 includes a concave groove 175a and a circular projection 175b (shown by two-dot chain line in the drawings). The concave groove 175a is formed in the side surface of the front lower portion of the stay 164 and has a predetermined length extending in the axial direction of the hammer bit 119. The circular projection 175b extends inward from the inner surface of the intermediate portion 105c of the housing 105 and is slidably engaged in the concave groove 175a.

As described above, by provision of the upper, lower and intermediate slide guides 171, 173, 175, the handgrip 109 is prevented from moving in a vertical direction transverse to the axial direction of the hammer bit 119 with respect to the housing 105, and thus rattling of the handgrip 109 in the vertical direction is reduced.

The hammer drill 101 according to this embodiment is constructed as described above. FIG. 3 shows an initial state of the handgrip 109 (the state in which the handgrip 109 is mounted to the housing 105). In this state, the handgrip 109 is biased rearward away from the housing 105 by the spring force of the coil springs 181, 183, and at least the protrusions 171b of the upper slide guide 171 are held in contact with the front end of the slot 171a. FIG. 4 shows the state in which the handgrip 109 is moved from the initial state to the housing 105 side (forward) as far as possible and the protrusions 171b come in contact with the rear end of the slot 171a (the state of maximum displacement). The maximum amount of relative movement (displacement) of the handgrip 109 is shown by L in FIG. 4.

An operation using the hammer drill 101 is performed while the user holds the grip part 161 of the handgrip 109 and applies a forward pressing force to the hammer drill 101. Specifically, the operation is performed in the state in which the protrusions 171b, the metal pins 173b and the circular projection 175b of the upper, lower and intermediate slide guides 171, 173, 175 are placed between the rear and front ends of the slot 171a and the concave grooves 173a, 175a, respectively. In this state, the handgrip 109 is allowed to move with respect to the housing 105 in the axial direction of the hammer bit 119. Therefore, during operation, vibration which is caused in the housing 105 and transmitted from the housing 105 to the handgrip 109 can be reduced by the coil springs 181, 183.

In this embodiment, as described above, the handgrip 109 is elastically connected to the housing 105 by the upper and lower coil springs 181, 183 and mounted to the housing 105 for relative movement in the axial direction of the hammer bit 119. Therefore, the coil springs 181, 183 absorb vibration by linear deformation in the axial direction of the hammer bit, so that the vibration absorption efficiency of the coil springs 181, 183 can be enhanced.

In the known rotary handgrip in which one end of the grip part in the extending direction (the vertical direction) is connected to the hammer body via a coil spring and the other end of the grip part is pivotally supported on a pivot, if an attempt is made to obtain a desired vibration proofing effect by causing the direction of deformation of the coil spring to be closer to the axial direction of the hammer bit, the distance between the pivot and the coil spring is widened, so that the size of the handgrip increase in the vertical direction. Therefore, like in this embodiment, with a construction in which the handgrip 109 linearly moves with respect to the hammer body in the axial direction of the hammer bit 119 in order to obtain a vibration proofing effect, the vertical length of the handgrip 109 is not restricted, so that the size of the handgrip 109 can be reduced.

Further, according to this embodiment, the lower arm 163 of the handgrip 109 can be slidably supported with stability by the lower extending portion 105b of the housing 105, and in addition, the lower extending portion 105b also serves as a mount for the battery pack 107. Therefore, a rational supporting structure can be realized.

Further, according to this embodiment, a rear region of the housing 105 is generally U-shaped in side view, having the upper and lower extending portions 105a, 105b extending rearward and the intermediate portion 105c extending therebetween, and the upper and lower arms 162, 163 and the stay 164 of the handgrip 109 are inserted into this generally U-shaped region. With this construction, the relatively wide smooth surfaces 162a, 163a, 164a can be formed on the right and left side surfaces of the arms 162, 163 and the stay 164, so that rattling of the handgrip 109 can be reduced in the lateral direction. Further, by provision of the upper, lower and intermediate slide guides 171, 173, 175, rattling of the handgrip 109 can be reduced in the vertical direction.

As described above, according to this embodiment, rattling of the handgrip 109 can be reduced in any direction except the axial direction of the hammer bit 119. Therefore, even if the spring constant of the coil springs 181, 183 is reduced, a sufficient vibration proofing effect can be obtained. Further, such a vibration-proof handgrip 109 feels comfortable to use.

Further, in this embodiment, the hammer drill is described as a representative example of the hand-held power tool, but the present invention can also be applied to a hammer in which the hammer bit 119 performs only the striking movement in the axial direction, or a cutting power tool, such as a reciprocating saw and a jig saw, which performs a cutting operation on a workpiece by reciprocating movement of a blade.

Further, in this embodiment, the battery-powered power tool is described in which the electric motor 111 is powered from the battery pack 107, but the present invention can also be applied to a power tool in which the electric motor 111 is AC powered.

As another representative embodiment of the invention, following features are provided.

1-1. A power tool, in which a housing houses a motor and an output section that is disposed forward of the motor and operated when the motor is driven, and the housing is separated into a body housing that includes a pair of right and left housing halves and houses the motor and a rear part of the output section, and a front housing that houses a front part of the output section, wherein:

an inner housing is provided within the body housing, which inner housing houses the rear part of the output section, protrudes forward from the body housing and is fixedly held between the housing halves, and the front housing is lapped on a protruding part of the inner housing and mounted to a front end of the body housing, such that the housing halves and the front housing can be individually removed.

1-2. The power tool as defined in claim 1, wherein the housing halves are fastened to each other by screws through cylindrical bosses which extend from inner surfaces of the housing halves, the bosses of the housing halves being coaxially butted against each other in the assembled state of the housing halves, and wherein the inner housing has a positioning hole through which the boss is inserted in the assembled state of the body housing, so that the inner housing can be fixedly positioned while the housing halves are fastened to each other by screws.

1-3. The power tool as defined in claim 1 or 2, wherein the motor is housed under the inner housing and arranged such that the output shaft is oriented upward and the motor is in a tilted position in which a lower end of the output shaft is located forward of an upper end of the output shaft, and wherein the upper end of the output shaft is inserted into the inner housing and engaged with a bevel gear at an input end of the output section.

According to the feature of 1-1, an inner housing is provided within the body housing, which inner housing houses the rear part of the output section, protrudes forward from the body housing and is fixedly held between the housing halves, and the front housing is lapped on a protruding part of the inner housing and mounted to a front end of the body housing, such that the housing halves and the front housing can be individually removed.

According to the feature of 1-2, in order to efficiently and accurately mount the inner housing in the body housing, the housing halves are fastened to each other by screws through cylindrical bosses which extend from inner surfaces of the housing halves, and the bosses of the housing halves are coaxially butted against each other in the assembled state of the housing halves. Further, the inner housing has a positioning hole through which the boss is inserted in the assembled state of the body housing, so that the inner housing can be fixedly positioned while the housing halves are fastened to each other by screws.

According to the feature of 1-3, in order to ensure transmission of rotation from the motor to the output section, the motor is housed under the inner housing and arranged such that the output shaft is oriented upward and the motor is in a tilted position in which a lower end of the output shaft is located forward of an upper end of the output shaft. Further, the upper end of the output shaft is inserted into the inner housing and engaged with a bevel gear at an input end of the output section.

According to the feature of 1-1, in order to repair either of a body housing side and a front housing side, only the one on the side to be repaired can be removed, while rigidity of a connection between the body housing and the front housing can be ensured, so that workability relating to repairs or other similar operations can be improved. According to the feature of 1-2, the inner housing can be efficiently and accurately mounted in the body housing. Therefore, the positioning relationship between the motor and the output section can be stabilized and no problem is caused in transmission of rotation. According to the feature of 1-3, transmission of rotation from the motor to the output section can be ensured.

Further, as another representative embodiment of the invention, following features are also provided.

2-1. A structure for positioning a rotating shaft in an axial direction of the rotating shaft with respect to a housing, in which a bearing is fitted on the rotating shaft and supported by the housing and a sleeve is press-fitted onto the rotating shaft on an upper end of the bearing and held in sliding contact with a sealing material provided between the rotating shaft and the housing, wherein:

an end of the sleeve is held in contact with one end surface of the bearing, and a bearing retainer is mounted on the housing and held in contact with the other end surface of the bearing, whereby the bearing is held between the sleeve and the bearing retainer, so that the rotating shaft is positioned in the axial direction.

2-2. The positioning structure as defined in claim 1, wherein the bearing retainer has a semicircular arc shape to be arranged in contact with half of an circumferential portion of the bearing.

2-3. The positioning structure as defined in claim 1 or 2, wherein an engaging claw is formed on the bearing retainer and the engaging claw is engaged with an engagement part formed on the housing and thus positions the bearing retainer in a mounting position on the housing.

According to the feature of 2-1, an end of the sealing sleeve is held in contact with one end surface of the bearing, and a bearing retainer is mounted on the housing and held in contact with the other end surface of the bearing. Thus, the bearing is held between the sleeve and the bearing retainer, so that the rotating shaft is positioned in the axial direction.

According to the feature of 2-2, in order to form the bearing retainer in a minimum structure, the bearing retainer has a semicircular arc shape to be arranged in contact with half of an circumferential portion of the bearing.

According to the feature of 2-3, in order to further facilitate mounting the bearing retainer, an engaging claw is formed on the bearing retainer and the engaging claw is engaged with an engagement part formed on the housing and thus positions the bearing retainer in a mounting position on the housing.

According to the feature of 2-1, the rotating shaft can be accurately positioned by a simple structure utilizing the existing sleeve. As a result, the rotating shaft can be held in proper engagement with the final-stage gear and thus obtain a favorable durability.

According to the feature of 2-2, the bearing retainer can be formed in a minimum structure required to position the rotating shaft. As a result, the cost of the bearing retainer can be reduced, and mounting of the bearing retainer to the housing can be facilitated.

According to the feature of 2-3, mounting of the bearing retainer to the housing can be further facilitated by utilizing the engaging claw.

An embodiment for the above-described respective features 1-1 to 1-3 and 2-1 to 2-3 is now described with reference to the drawings.

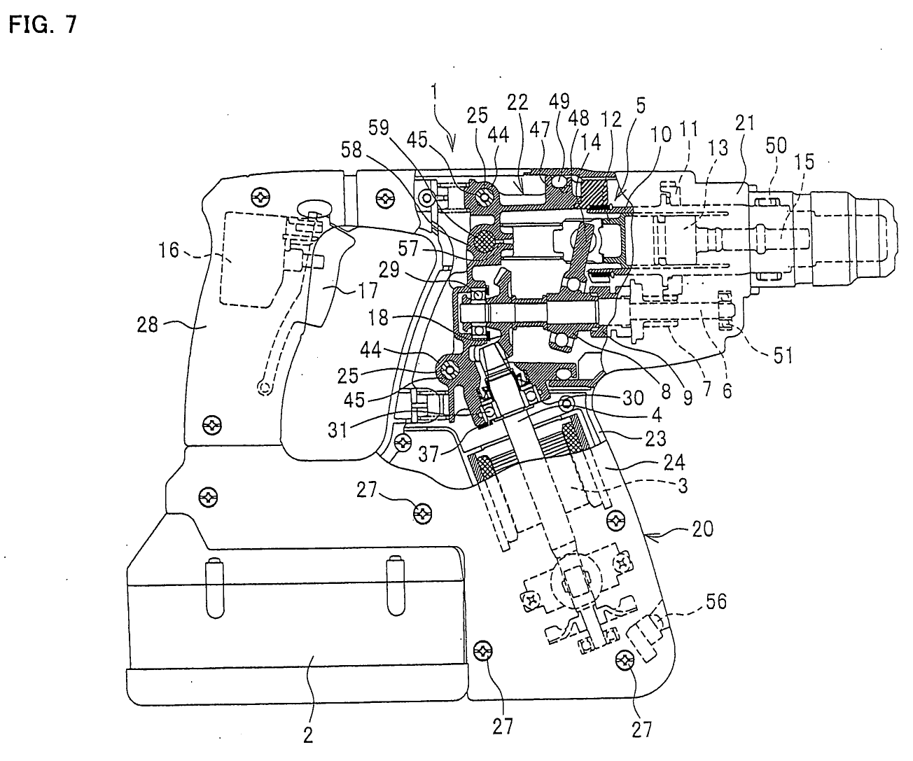

FIG. 7 is a view showing an entire hammer drill 1 as a representative embodiment of the power tool according to the present invention. In the hammer drill 1, a battery 2 is mounted on the underside of the rear (shown on the left in FIG. 7) of the hammer drill and a motor 3 is housed in front of the battery 2 such that an output shaft 4 is oriented upward. An output section 5 is disposed above the motor 3. In the output section 5, an intermediate shaft 6 is supported in the longitudinal direction, and a first gear 7 and a swash bearing 8 are fitted on the intermediate shaft 6 one behind the other such that they can individually rotate separately from the intermediate shaft 6. A clutch sleeve 9 is arranged between the first gear 7 and the swash bearing 8 such that it can rotate together with the intermediate shaft 6 and can slide in its axial direction. Further, a cylindrical tool holder 10 is supported above the intermediate shaft 6 and in parallel therewith, and a second gear 11 that engages with the first gear 7 is integrally fitted on the tool holder 10. A piston cylinder 12 is loosely fitted in the tool holder 10 such that it can reciprocate, and a striker 13 is disposed within the piston cylinder 12. The rear end of the piston cylinder 12 is connected to an arm 14 of the swash bearing 8. Further, an impact bolt 15 is housed within a front portion of the piston cylinder 12 such that it can move in the longitudinal direction.

When an operating knob (not shown) is operated to slide the clutch sleeve 9 forward into engagement only with the first gear 7, rotation of the intermediate shaft 6 is transmitted to the first gear 7 via the clutch sleeve 9 and then to the tool holder 10 via the second gear 11. As a result, a bit (not shown) coupled to the front end of the tool holder 10 rotates together with the tool holder 10 (“drill mode”). On the other hand, when the clutch sleeve 9 is slid rearward into engagement only with the swash bearing 8, rotation of the intermediate shaft 6 is transmitted to the swash bearing 8 via the clutch sleeve 9. As a result, the arm 14 swings in the longitudinal direction and moves the piston cylinder 12 back and forth, which in turn causes the striker 13 to be interlocked to strike the impact bolt 15 and thus strike the bit (“hammer mode”). Further, when the clutch sleeve 9 is engaged with both the first gear 7 and the swash bearing 8, both the first gear 7 and the swash bearing 8 rotate, so that the bit is struck while rotating (“hammer drill mode”)

A housing of the hammer drill 1 has two parts, or a body housing 20 and a front housing 21. The body housing 20 covers all over a rear region of the hammer drill 1 which includes a rear part of the output section 5 and the motor 3, and the front housing 21 covers a front part of the output section 5 in front of the body housing 20. Further, the rear part of the output section 5 is housed within an inner housing 22 installed within the body housing 20.

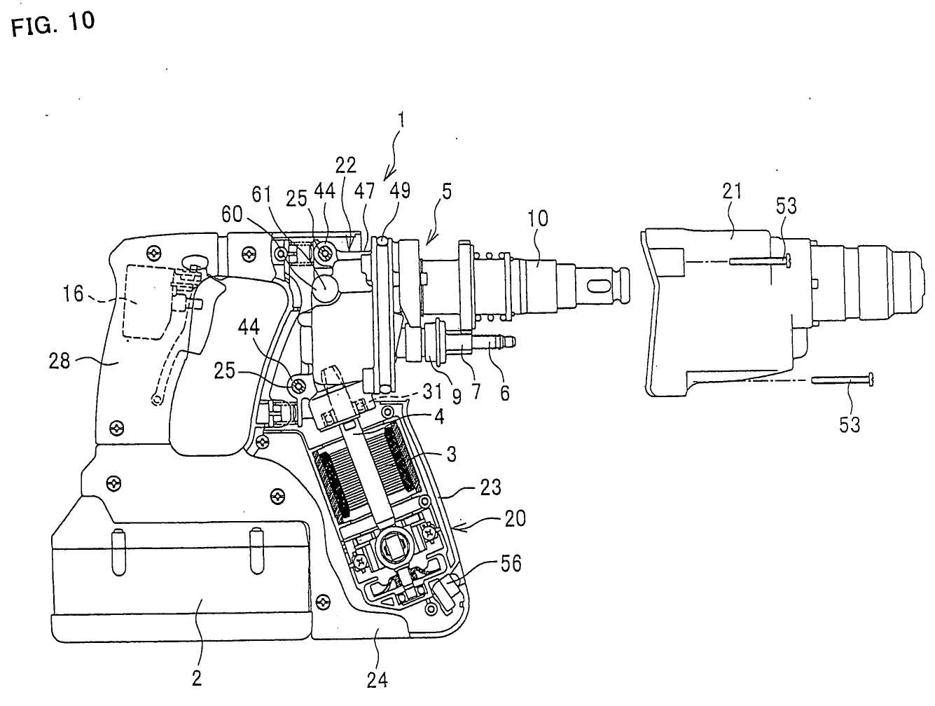

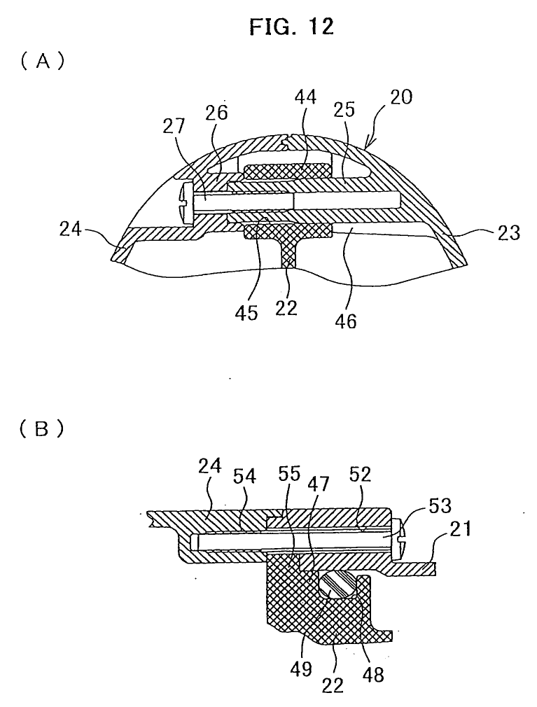

As shown in FIG. 10 and FIG. 12(A), the body housing 20 is formed by housing halves in the form of a pair of right and left housings 23, 24. Cylindrical bosses 25 each having a threaded bore extend from an inner surface of the left housing 23, and cylindrical bosses 26 each having a through bore extend from an inner surface of the right housing 24. When the right and left housings 23, 24 are assembled together, the bosses 26 are fitted on the bosses 25 in a coaxially butted manner. Therefore, the right and left housings 23, 24 are assembled into the body housing 20 by inserting screws 27 through each of the bosses 26 from the right housing 24 side and threadably into the associated bosses 25. Further, a handle 28 is connected to an upper portion of the rear end of the body housing 20. The handle 28 houses a switch 16 which is actuated to drive the motor 3, and the handle 28 has a switch lever 17 which is depressed to turn on the switch 16.

Further, the inner housing 22 has a box-like shape having an open front end and a closed rear end. The inner housing 22 supports a rear end of the intermediate shaft 6 via a ball bearing 29 which is provided within the rear of the inner housing 22. Further, an insert hole 30 is formed through the bottom of the inner housing 22, and the output shaft 4 of the motor 3 is inserted into the inner housing 22 through the insert hole 30 such that a ball bearing 31 mounted on the output shaft 4 is fitted in the insert hole 30. In this manner, the inner housing 22 supports the output shaft 4. The motor 3 here is arranged within the body housing 20 in a tilted position in which the lower end of the output shaft 4 is located forward of the upper end of the output shaft 4. The upper end of the output shat 4 is inserted into the inner housing 22 through the insert hole 30 and engaged with a bevel gear 18, so that rotation of the output shaft 4 can be transmitted to the intermediate shaft 6. The bevel gear 18 is fixedly mounted on the rear end portion of the intermediate shaft 6 and located at an input end of the output section 5.

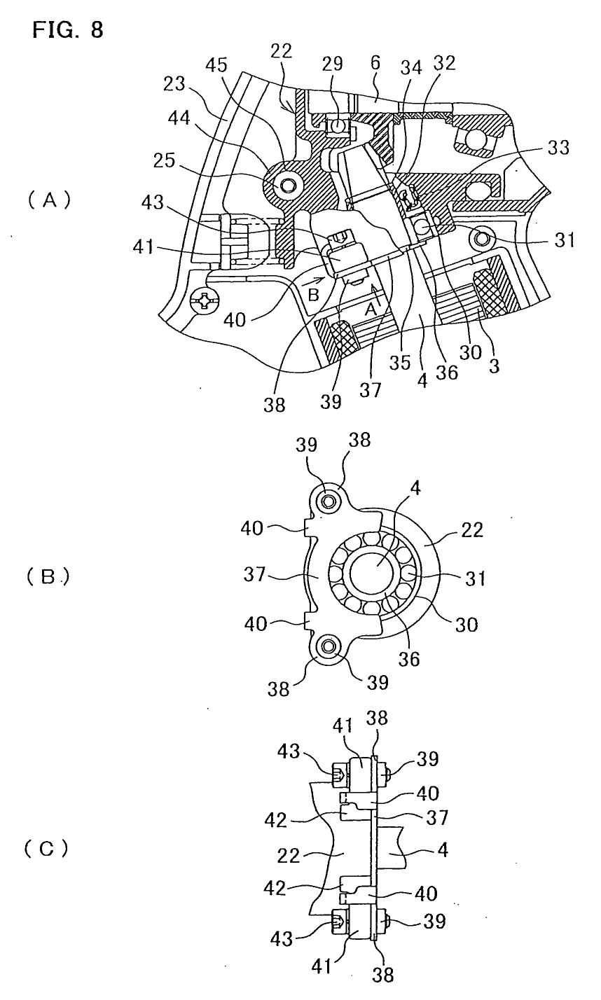

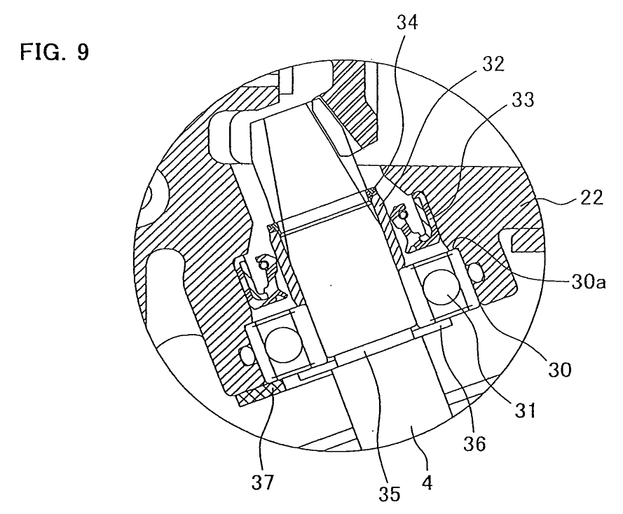

As shown in FIG. 8, a sleeve 32 is press-fitted onto the output shaft 4 on the upper end of the ball bearing 31 and a sealing material in the form of an oil seal 33 which is retained within the insert hole 30 is held in sliding contact with the sleeve 32, so that the inner housing 22 is sealed. A retaining ring 34 is engaged on the output shaft 4 on the upper end of the sleeve 32. Further, a constricted part (groove) 35 is formed in the output shaft 4 at a position corresponding to the opening edge of the insert hole 30, and a stopper ring 36 is fitted in the constricted part 35. The stopper ring 36 is held in contact with an outer end surface of the ball bearing 31 fitted on the output shaft 4.

A bearing retainer 37 is mounted on the opening edge of the insert hole 30 of the inner housing 22. The bearing retainer 37 has a semicircular arc shape to be arranged in contact with half of an circumferential portion of the outer end surface of the ball bearing 31. A pair of ring-shaped mounting parts 38 extend radially outward from both end portions (upper and lower portions in the vertical direction as viewed in FIG. 8(B) and FIG. 8(C)) of the bearing retainer 37. A nut 39 is fixedly mounted on each of the mounting parts 38, and a pair of engaging claws 40 are formed on the bearing retainer 37 between the mounting parts 38 and folded up away from the nut 39 into an L-shape.

Correspondingly, a pair of screw fastening parts 41 are formed on upper and lower portions (as viewed in FIG. 8(B) and FIG. 8(C)) of the inner housing 22. The screw fastening parts 41 each have a thickness large enough to be engaged and locked by the engaging claws 40 and each have a protrusion 42 on its end which faces an end of the other.

When the engaging claws 40 of the bearing retainer 37 are engaged on the screw fastening parts 41, the engaging claws 40 come into contact with the protrusions 42 and thus lock the bearing retainer 37 against vertical movement (as viewed in FIG. 8(B) and FIG. 8(C)). Thus, the bearing retainer 37 is positioned in a mounting position in which the centers of the mounting part 38 and the nut 39 are aligned with a through hole (not shown) of the screw fastening part 41. In this state, a setscrew 43 is inserted through the screw fastening part 41 and the mounting part 38 and screwed into the nut 39. Thus, the bearing retainer 37 is fastened in contact with the opening edge of the insert hole 30 and the outer end surface of the ball bearing 31, and thus, at the opening edge of the insert hole 30, it prevents the ball bearing 31 from slipping out. Thus, the sleeve 32 abuts against the ball bearing 31 mounted on the output shaft 4, from above or from the upper end of the output shaft 4, while the bearing retainer 37 also abuts against the ball bearing 31 from below or from the opposite side, so that the output shaft 4 is positioned without rattling in its axial direction.

Further, cylindrical portions 44 are formed on upper and lower portions of the rear end of the inner housing 22 and each have a positioning hole 45 through which the associated boss 25 of the left housing 23 is inserted in the assembled state of the body housing 20. In the state in which the boss 25 is inserted through the positioning hole 45, as shown in FIG. 12(A), an end surface of the cylindrical portion 44 is held in contact with a rib 46 which extends from the outer periphery of the boss 25 to an inner surface of the left housing 23. In the state in which the inner housing 22 is thus connected to the left housing 23, the right housing 24 is connected to the left housing 23. At this time, the boss 26 of the right housing 24 comes into contact with the end surface of the cylindrical portion 44, so that the cylindrical portion 44 is centrally positioned in the lateral direction. Specifically, assembling of the body housing 20 by the screws and fixed positioning of the inner housing 22 by the bosses 25, 26 can be simultaneously attained.

Furthermore, the front end of the inner housing 22 or a protruding part 47 protrudes forward of the front open end of the body housing 20, and an O-ring 49 is fitted in a circumferential groove 48 formed in an outer surface of the protruding part 47.

The front housing 21 has a rear end opening which conforms to the front end opening of the body housing 20. The front housing 21 has a tapered cylindrical shape covering the front portion of the inner housing 22 and the front ends of the tool holder 10 and the intermediate shaft 6. A bearing 50 for supporting the tool holder 10 and a ball bearing 51 for supporting a front end of the intermediate shaft 6 are formed on the inside of the front housing 21. In order to assemble the front housing 21 and the body housing 20, as shown in FIG. 12(B), a screw 53 is inserted through a through hole 52 formed in the rear end of the front housing 21, and then screwed into a threaded hole 54 formed in the front end of each of the left and right housings 23, 24. In this assembled state, a rib 55 which is formed on the outer surface of the protruding part 47 of the inner housing 22 and extends in the circumferential direction is held between the body housing 20 and the front housing 21, and the O-ring 49 is held in contact with the inner surface of the front housing 21.

An LED 56 is housed in a front lower portion of the body housing 20 below the motor 3 and oriented forward and obliquely upward such that it can illuminate a region ahead of the bit mounted to the tool holder 10. Particularly in this embodiment, the lower portion of the body housing 20 is configured to correspond to the tilt of the motor 3, or specifically, it has an oblique shape gradually protruding forward toward its lower end. The LED 56 is located substantially at the protruding end of the inclined portion of the body housing 20, so that it can effectively illuminate an area to be worked on, from the front end of the body housing 20.

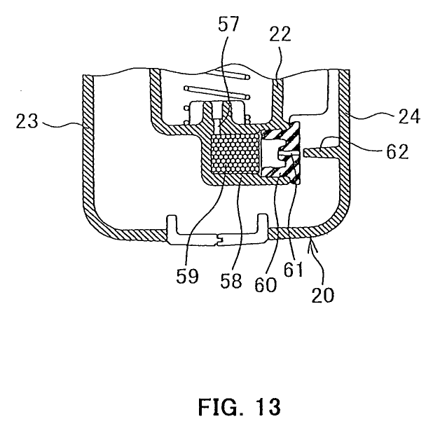

An air-bleeding hole 57 is formed in the rear end of the inner housing 22 behind the piston cylinder 12 and extends through it in the longitudinal direction as shown in FIG. 13. Further, a cylindrical portion 58 having a bottom is formed on the rear surface of the inner housing 22 and configured to communicate with the air-bleeding hole 57. The cylindrical portion 58 has a longitudinal axis perpendicular to the air-bleeding hole 57 such that it has an open top or end on the right side (as viewed in FIG. 13). The cylindrical portion 58 is filled with a felt filter 59, and a filter cap 60 is fitted to the open top of the cylindrical portion 58 in such a manner as to prevent the filter 59 from slipping out. The filter cap 60 has a cylindrical shape having a bottom and having an open top which faces the filter 59, and an exhaust hole 61 is formed through the center of the closed bottom along its axis of the cylindrical filter cap. Further, a protrusion 62 is formed on the inner surface of the right housing 24 and arranged and configured to extend close to the exhaust hole 61 of the filter cap 60 in the assembled state, in order to prevent removal of the filter cap 60.

When the temperature within the inner housing 22 increases by heat generation which is caused by operation of the output section 5 and the inside air expands, the air is introduced into the cylindrical portion 58 via the air-bleeding hole 57 and discharged through the exhaust hole 61 of the filter cap 60. At this time, even if lubricating oil (such as grease) within the inner housing 22 enters the cylindrical portion 58 through the air-bleeding hole 57 together with the air, the filter 59 can absorb it. Furthermore, even if lubricating oil overflows the filter 59, the filter cap 60 can hold it back, so that it is prevented from entering the body housing 20 through the exhaust hole 61.

Particularly in this embodiment, the exhaust hole 61 is arranged to be oriented in a direction perpendicular to the longitudinally extending air-bleeding hole 57 and to face toward the right housing 24. Therefore, a rational construction can be realized in which, concurrently with the assembling operation of the right housing 24, the protrusion 60 serves to prevent removal of the filter cap 60.

In the hammer drill 1 having the above-described construction, in order to assemble the body housing 20 and fixedly position the inner housing 22 in the body housing 20 at the same time as described above, the motor 3 and the inner housing 22 with the output section 5 housed therein are set on the left housing 23 to which the handle 28 is already connected, and in this state, the right housing 24 is set on the left housing 23 from above and fastened thereto by screws. In order to mount the output shaft 4 to the inner housing 22, first, the stopper ring 36, the ball bearing 31, the sleeve 32 and the retaining ring 34 are mounted in respective positions on the output shaft 4. In this state, the output shaft 4 is inserted into the insert hole 30 to which the oil seal 33 is mounted. Then the upper end of the ball bearing 31 is fitted in an engagement portion 30a which is formed in the insert hole 30 and shaped to fit the ball bearing 31. Finally, the bearing retainer 37 is fastened to the inner housing 22 by the setscrews 43.

Thereafter, the front housing 21 is mounted to the front of the body housing 20 in such a manner as to cover it from the front of the output section 5, and fastened by screws. In this manner, as shown in FIG. 7, assembly of the hammer drill 1 is completed. In this state, the front housing 21 is integrally connected not only to the body housing 20 but to the protruding part 47 of the inner housing 22, so that rigidity of the connection between the body housing 20 and the front housing 21 can be ensured.

When, for example, the output section 5 is in need of repair or maintenance, for this purpose, as shown in FIG. 10, only the front housing 21 can be removed while the body housing 20 is held as-is, by unscrewing the screws 53 that fixate the front housing 21 to the body housing 20.

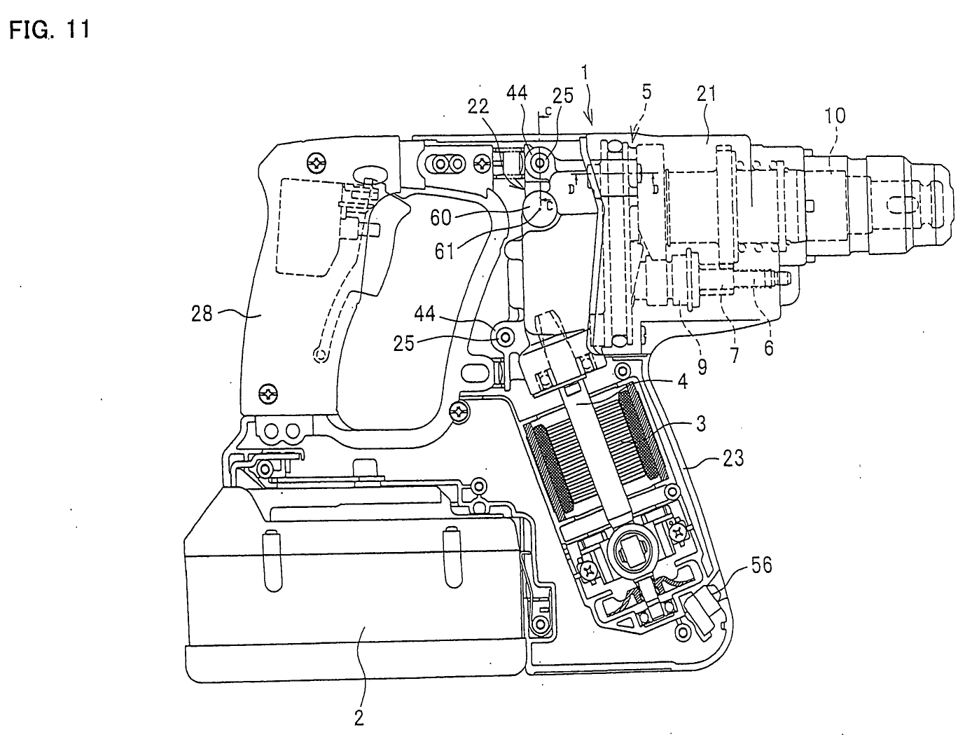

Further, when, for example, the motor 3 side is in need of repair or maintenance, for this purpose, as shown in FIG. 11, only the right housing 24 can be removed while the front housing 20 is held as-is, by unscrewing the screws 27 that fixate the right and left housings 23, 24 and the screws 53 that fixate the front housing 21 to the right housing 24.

Thus, according to the hammer drill 1 in this embodiment, the inner housing 22 provided within the body housing 20 houses part of the output section 5, protrudes forward from the body housing 20 and is fixedly held between the right and left housings 23, 24. Further, the front housing 21 is lapped on the protruding part 47 of the inner housing 22 and mounted to the front end of the body housing 20, such that the right and left housings 23, 24 and the front housing 21 can be individually removed. As a result, rigidity of the connection between the body housing 20 and the front housing 21 can be ensured. In addition, in order to repair either of the body housing 20 side and the front housing 21 side, only the one on the side to be repaired can be removed. Thus, workability relating to repairs or other similar operations can be improved.

Particularly in this embodiment, the right and left housings 23, 24 are fastened to each other by screws through the cylindrical bosses 25, 26 which extend from the inner surfaces of the right and left housings 23, 24. The bosses 25, 26 are coaxially butted against each other in the assembled state of the right and left housings 23, 24. Further, the inner housing 22 has the positioning hole 45 through which the boss 25 is inserted in the assembled state of the body housing 20, so that the inner housing 22 can be fixedly positioned while the right and left housings 23, 24 are fastened to each other by screws. Thus, the inner housing 22 can be efficiently and accurately mounted in the body housing 20. Therefore, the positioning relationship between the motor 3 and the output section 5 can be stabilized and no problem is caused in transmission of rotation.

Further, the motor 3 is housed under the inner housing 22 and arranged such that the output shaft 4 is oriented upward and the motor 3 is in a tilted position in which the lower end of the output shaft 4 is located forward of the upper end of the output shaft 4. Further, the upper end of the output shaft 4 is inserted into the inner housing 22 and engaged with the bevel gear 18 at the input end of the output section 5. With this construction, transmission of rotation from the motor 3 to the output section 5 can be ensured.

Further, in this embodiment, the rib 55 which extends in the circumferential direction on the inner housing 22 is held between the body housing 20 and the front housing 21, but, in place of the rib 55, discontinuously extending projections may be used. Further, without using this structure of holding the rib, it may be constructed such that the protruding part of the inner housing is simply held in contact with the inner surface of the front housing.

Further, the number and configuration of the positioning holes 45 are not limited to those in the above embodiment. For example, they may be formed not in the cylindrical portion but in a plate-like part, or depending on the position of the bosses, they may be formed not only on the rear of the inner housing but on the top and the bottom of the inner housing. It is naturally possible to dispense with the positioning holes, and it may be constructed to hold the outer surface of the inner housing by a rib or a recessed seat formed in the inner surface of a housing part.

Further, the hammer drill is not limited to the type in which the motor is housed in a tilted position within the front lower portion of the hammer drill. For example, it may be constructed such that the motor is housed not in a tilted position but in a vertical position, or such that the motor is housed behind the output section and oriented forward. In the above-described embodiment, however, the motor is located forward of the heavy battery, so that the hammer drill can have a better balance as a whole. Further, the handle is located right behind the output section and on the axis of the bit, so that the hammer drill can be pressed forward at a rearward position nearer to the bit on the axis of the bit. Therefore, ease of use can be enhanced.

Other design changes or modifications can also be made to the other parts. For example, in the output section, a crank mechanism may be used in place of the swash bearing, or a fixed cylinder and a piston which reciprocates with respect to the cylinder may be used in place of the piston cylinder. Or an AC power source may be used instead of the DC power source.

The present invention is not limited to the hammer drill, but it can also be applied to other power tools, such as an electric hammer, an electric drill and an impact driver, in which its housing can be separated into a body housing and a front housing.

Further, according to the hammer drill 1, an end of the sleeve 32 press-fitted onto the output shaft 4 is held in contact with one end surface of the ball bearing 31, and the bearing retainer 37 on the inner housing 22 is held in contact with the other end surface of the ball bearing 31. Thus, the ball bearing 31 is held between the sleeve 32 and the bearing retainer 37, so that the output shaft 4 is positioned in its axial direction. Thus, the output shaft 4 can be accurately positioned by a simple structure utilizing the existing sleeve 32. As a result, the output shaft 4 can be held in proper engagement with the bevel gear 18 and thus obtain a favorable durability.

Particularly, by provision of the bearing retainer 37 having a semicircular arc shape to be arranged in contact with half of a circumferential portion of the outer end surface of the ball bearing 31, the bearing retainer 37 can be formed in a minimum structure required to position the output shaft 4. As a result, the cost of the bearing retainer 37 can be reduced, and the bearing retainer 37 can be easily mounted to the inner housing 22.

Further, by provision of the engaging claws 40 which are formed on the bearing retainer 37 and which are engaged with the screw fastening parts 41 formed on the inner housing 22 and thus position the bearing retainer 37 in a mounting position on the inner housing 22, the bearing retainer 37 can be more easily mounted to the inner housing 22.

Further, the output shaft of the motor is provided with a positioning structure, but, even in a construction, for example, in which an intermediate shaft is supported in parallel to the output shaft between the output shaft and a gear at the input end of the output section such that rotation of the output shaft can be transmitted to the gear at the input end and the intermediate shaft is engaged with the gear, any positioning structure having a bearing retainer can also be used only if a sealing sleeve is provided on the bearing part of the intermediate shaft.

Further, the bearing retainer may be mounted from the other half side from a direction opposite from the mounting direction in the above-mentioned embodiment, or from above the output shaft. The bearing retainer may have a shape other than the semicircular arc shape, such as a C-shape or a ring-like shape. Further, it is not limited to one, but a plurality of bearing retainers having, for example, a short arcuate shape can also be mounted.

In addition, in relation to mounting of the bearing retainer to the housing, design changes or modifications can also be appropriately made. For example, the bearing retainer may be fastened by screws from the side of the opening of the insert hole, or the engaging claws may be dispensed with.

Further, the bearing is not limited to the ball bearing, but a needle bearing, bearing metal and other types of bearings can also be used according to this invention. Naturally, the power tool to be applied includes not only the hammer drill, but other types of power tools.

### DESCRIPTION OF NUMERALS

101 hammer drill (hand-held power tool)
103 body (power tool body)
105 housing
105a upper extending portion
105b lower extending portion
105c intermediate portion
105L left housing half
105R right housing half
107 battery pack
109 handgrip (handle)
109a trigger
109b electric switch
109L left handgrip half
109R right handgrip half
111 electric motor
113 motion converting mechanism
115 striking mechanism
117 power transmitting mechanism
119 bit (tool bit)
121 driving gear
123 driven gear
125 intermediate shaft
127 rotating element
129 swinging ring
131 first transmission gear
133 second transmission gear
137 tool holder
141 cylindrical piston
143 striker
145 impact bolt
151 dowel
153 dowel hole
155 screw
161 grip part
162 upper arm
162a smooth surface
163 lower arm
163a smooth surface
164 stay (transverse part)
164a smooth surface (sliding surface)
165 opening edge
167 dowel
168 dowel hole
169 screw
171 upper slide guide (guide)
171a slot
171b protrusion
173 lower slide guide (guide)
173a concave groove
173b metal pin
175 intermediate slide guide
175a concave groove
175b circular projection
181 upper coil spring (elastic element)
183 lower coil spring (elastic element)
185 inner housing

What we claim is:

1. A hand-held power tool to perform a predetermined operation on a workpiece by linearly driving a tool bit comprising:
a power tool body having a tip end region to which the tool bit is coupled,
a handle provided on the rear of the power tool body opposite to the tool bit, the handle being held by a user of the power tool, wherein the handle is connected to the power tool body via an elastic element and can slide with respect to the power tool body in an axial direction of the tool bit and
an extending region provided with the power tool body, the extending region extending to a lower region of the handle to receive the sliding movement of the handle.

2. The power tool as defined in claim 1, wherein the handle includes:
a grip part that extends in a vertical direction transverse to the axial direction of the tool bit,
upper and lower arms that extend from extending ends of the grip part in the axial direction of the tool bit and
a transverse part that connects extending ends of the upper and lower arms, wherein the handle is configured as a closed-loop frame structure by the grip part, upper and lower arms and the transverse part.

3. The power tool as defined in claim 2, wherein the handle has a side surface region parallel to the axial direction of the tool bit and the side surface region has a sliding surface that slides with respect to the power tool body.

4. The power tool as defined in claim 3, wherein the sliding surface includes a first sliding region extending in the axial direction of the tool bit and a second sliding region extending in a vertical direction transverse to the extending direction of the first sliding region.

5. The power tool as defined in claim 1 further comprising an electric motor to drive the tool bit and a battery pack from to power the electric motor, wherein the extending region extending to the lower region of the handle forms a battery pack mounting part to which the battery pack is detachably mounted.

6. The power tool as defined in claim 1 further comprising a guide that connects the power tool body and the handle to each other respectively at upper and lower end portions of the handle, wherein the guide allows the handle to slide with respect to the power tool body in the axial direction of the tool bit, while preventing the handle from moving with respect to the power tool body in a direction other than the axial direction of the tool bit.

7. The power tool as defined claim 6, wherein the guide includes a concave groove extending in the axial direction of the tool bit and a projection that is engaged with the concave groove for relative movement, wherein the projection is defined by a metal pin.
